(19) United States
(12) Patent Application Publication
(10) Pub. No.: US 2012/0191954 A1
(43) Pub. Date: Jul. 26, 2012

(54) PROCESSOR HAVING INCREASED PERFORMANCE AND ENERGY SAVING VIA INSTRUCTION PRE-COMPLETION

(75) Inventors: Jay FLEISCHMAN, Ft. Collins, CO (US); Debjit DAS SARMA, San Jose, CA (US)

(73) Assignee: ADVANCED MICRO DEVICES, INC., Sunnyvale, CA (US)

(21) Appl. No.: 13/010,440

(22) Filed: Jan. 20, 2011

(51) Int. Cl. G06F 9/30

(52) U.S. Cl. 712/220; 712/E09.016

(57) ABSTRACT

Methods and apparatuses are provided for achieving increased performance and energy saving via instruction pre-completion without having to schedule instruction execution in processor execution units. The apparatus comprises an operational unit for determining whether an instruction can be completed without scheduling use of an execution unit of the processor and units within the operational unit capable of employing alternate or equivalent processes or techniques to complete the instruction. In this way, the instruction is completed without scheduling use of the execution unit of the processor. The method comprises determining that an instruction can be completed without scheduling use of an execution unit of a processor and then pre-completing the instruction without use of one or more the execution units.

### FIELD OF THE INVENTION

The present invention relates to the field of information or data processing. More specifically, this invention relates to the field of implementing a processor achieving increased performance and energy saving via instruction pre-completion without having to schedule instruction execution in processor execution units.

### BACKGROUND

In conventional processor architectures, instructions require an operation in an execution unit to be completed. For example, an instruction could be an arithmetic instruction (e.g., add and subtract), requiring an integer or floating-point computation unit to execute the instruction and return the result. Generally, processors decode instructions to determine what needs to be done. Next, the instruction is scheduled for execution and any necessary operands and source or destination registers are identified. At execution time, data and/or operands are read from source registers, the instruction is processed and the result returned to a destination register. By processing all instructions in the same manner, conventional processors have the potential to waste operational cycles and power by scheduling and executing instructions that could be performed without use of an execution unit. Moreover, latency increases since scheduling an instruction that could be completed without use of an execution unit prevents other instructions from being processed.

### BRIEF SUMMARY OF EMBODIMENTS OF THE INVENTION

An apparatus is provided for achieving increased performance and energy saving via instruction pre-completion without having to schedule instruction execution in all the processor execution units. The apparatus comprises an operational unit for determining whether an instruction can be completed without scheduling use of an execution unit of the processor, and units within the operational unit capable of completing the instruction outside the conventional schedule and execute paths. In this way, the instruction is completed without use of one or more execution units of the processor.

A method is provided for achieving increased performance and energy saving via instruction pre-completion without having to schedule instruction execution in processor execution units. The method comprises determining that an instruction can be completed without use of an execution unit of a processor and then pre-completing the instruction without the execution unit such as by employing alternate or equivalent processes or techniques to complete the instruction.

### BRIEF DESCRIPTION OF THE DRAWINGS

The present invention will hereinafter be described in conjunction with the following drawing figures, wherein like numerals denote like elements, and

FIG. 1 is a simplified exemplary block diagram of processor suitable for use with the embodiments of the present disclosure;

FIG. 2 is a simplified exemplary block diagram of computational unit suitable for use with the processor of FIG. 1;

FIGS. 3A and 3B are simplified exemplary block diagrams illustrating instruction pre-completion according to an embodiment of the present disclosure; and

FIG. 4 is a flow diagram illustrating instruction pre-completion according to an embodiment of the present disclosure.

### DETAILED DESCRIPTION OF EMBODIMENTS OF THE INVENTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. Moreover, as used herein, the word “processor” encompasses any type of information or data processor, including, without limitation, Internet access processors, Intranet access processors, personal data processors, military data processors, financial data processors, navigational processors, voice processors, music processors, video processors or any multimedia processors. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, the following detailed description or for any particular processor microarchitecture.

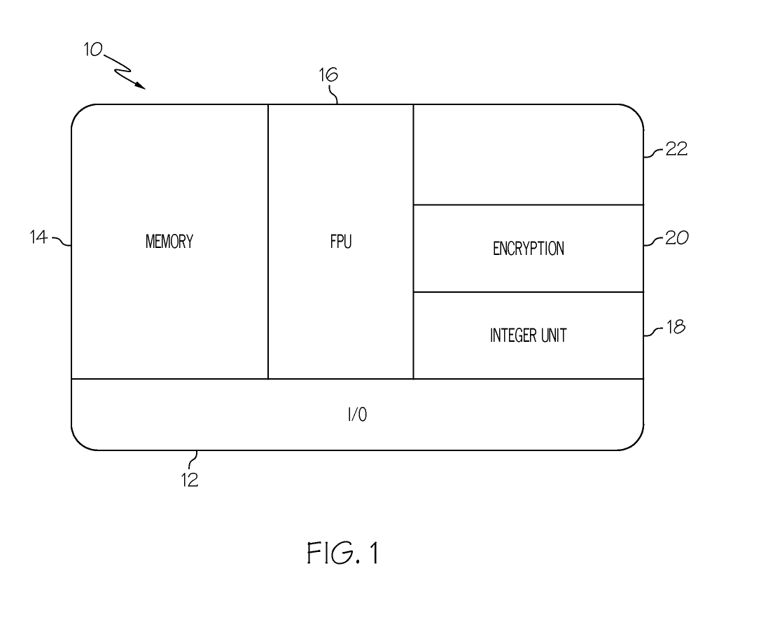

Referring now to FIG. 1, a simplified exemplary block diagram is shown illustrating a processor 10 suitable for use with the embodiments of the present disclosure. In some embodiments, the processor 10 would be realized as a single core in a large-scale integrated circuit (LSIC). In other embodiments, the processor 10 could be one of a dual or multiple core LSIC to provide additional functionality in a single LSIC package. As is typical, processor 10 includes an input/output (I/O) section 12 and a memory section 14. The memory 14 can be any type of suitable memory. This would include the various types of dynamic random access memory (DRAM) such as SDRAM, the various types of static RAM (SRAM), and the various types of non-volatile memory (PROM, EPROM, and flash). In certain embodiments, additional memory (not shown) “off chip” of the processor 10 can be accessed via the I/O section 12. The processor 10 may also include a floating-point unit (FPU) 16 that performs the float-point computations of the processor 10 and an integer processing unit 18 for performing integer computations. Additionally, an encryption unit 20 and various other types of units (generally 22) as desired for any particular processor microarchitecture may be included.

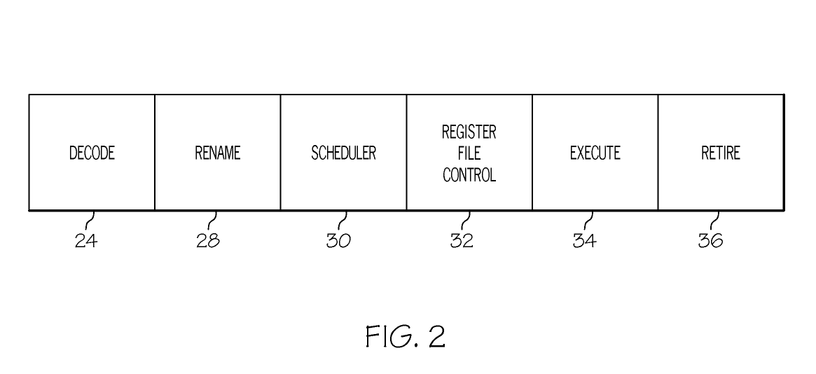

Referring now to FIG. 2, a simplified exemplary block diagram of a computational unit suitable for use with the processor 10 is shown. In one embodiment, FIG. 2 could operate as the floating-point unit 16, while in other embodiments FIG. 2 could illustrate the integer unit 18.

In operation, the decode unit 24 decodes the incoming operation-codes (opcodes) to be dispatched for the computations or processing. The decode unit 24 is responsible for the general decoding of instructions (e.g., x86 instructions and extensions thereof) and how the delivered opcodes may change from the instruction. The decode unit 24 will also pass on physical register numbers (PRNs) from an available list of PRNs (often referred to as the Free List (FL)) to the rename unit 28.

The rename unit 28 maps logical register numbers (LRNs) to the physical register numbers (PRNs) prior to scheduling and execution. According to various embodiments of the present disclosure, the rename unit 28 can be utilized to rename or remap logical registers in a manner that eliminates the need to store known data values in a physical register. In one embodiment, this is implemented with a register mapping table stored in the rename unit 28. According to the present disclosure, renaming or remapping registers saves operational cycles and power, as well as decreases latency.

The scheduler 30 contains a scheduler queue and associated issue logic. As its name implies, the scheduler 30 is responsible for determining which opcodes are passed to execution units and in what order. In one embodiment, the scheduler 30 accepts renamed opcodes from rename unit 28 and stores them in the scheduler 30 until they are eligible to be selected by the scheduler to issue to one of the execution pipes.

The register file control 32 holds the physical registers. The physical register numbers and their associated valid bits arrive from the scheduler 30. Source operands are read out of the physical registers and results written back into the physical registers. In one embodiment, the register file control 32 also checks for parity errors on all operands before the opcodes are delivered to the execution units. In a multi-pipelined (super-scalar) architecture, an opcode (with any data) would be issued for each execution pipe.

The execute unit(s) 34 may be embodied as any generation purpose or specialized execution architecture as desired for a particular processor. In one embodiment the execution unit may be realized as a single instruction multiple data (SIMD) arithmetic logic unit (ALU). In another embodiment, dual or multiple SIMD ALUs could be employed for super-scalar and/or multi-threaded embodiments, which operate to produce results and any exception bits generated during execution.

In one embodiment, after an opcode has been executed, the instruction can be retired so that the state of the floating-point unit 16 or integer unit 18 can be updated with a self-consistent, non-speculative architected state consistent with the serial execution of the program. The retire unit 36 maintains an in-order list of all opcodes in process in the floating-point unit 16 (or integer unit 18 as the case may be) that have passed the rename 28 stage and have not yet been committed by to the architectural state. The retire unit 36 is responsible for committing all the floating-point unit 16 or integer unit 18 architectural states upon retirement of an opcode.

According to embodiments of the present disclosure, instructions are identified that can be pre-completed without scheduling that instruction for execution in an execution unit. Pre-completed (or pre-completing) in this sense, means using processes or processor architectural improvements to complete certain instructions without using one or more execution unit(s). That is, instructions are pre-completed from the perspective of one or more execution units since those execution units are not utilized for processing instruction as in conventional processor architectures. By using alternate or equivalent techniques, processes or processor architectural improvements to pre-complete instructions, operational cycles and power are saved and latency is reduced by bypassing or avoiding the scheduling and certain execution stages. Certain examples of such instructions are presented below, however, these examples do not limit the scope of the present disclosure and numerous other instructions from various processor architectures and/or instructions sets can benefit from the advantages of the present disclosure.

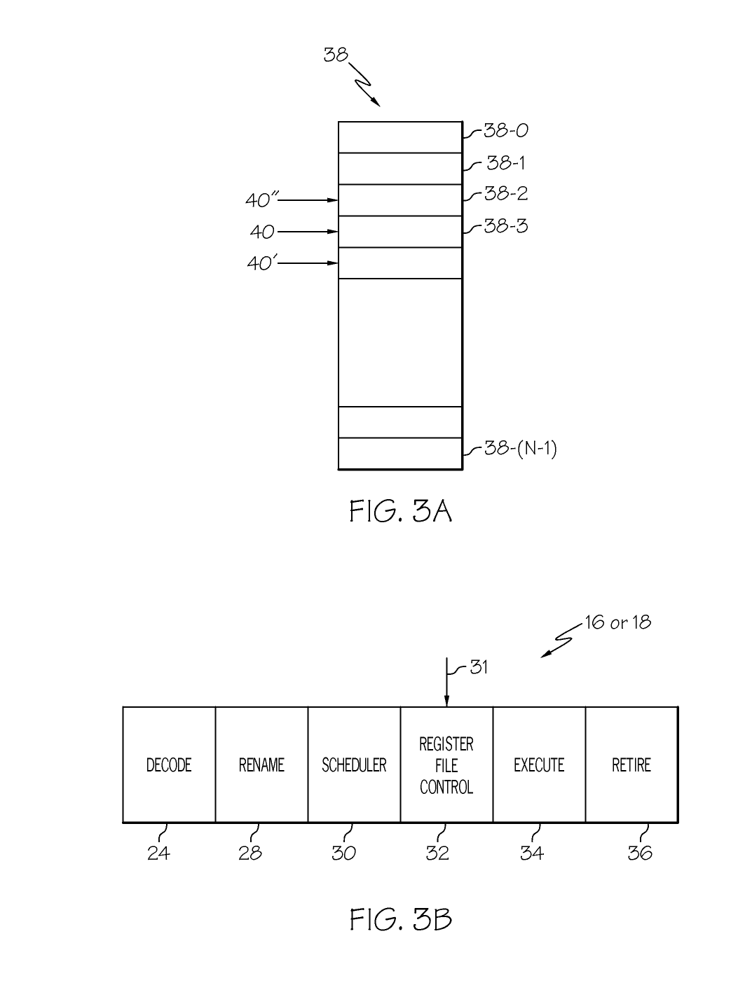

Referring now to FIG. 3A, there is shown an illustration of a register stack 38. Stacks are well known in the processor arts and can reside in any part of a processor in any portion of the address space. Stacks generally have a stack pointer 40, which may be a hardware register, that points to the most recently referenced location on the stack. The x87 instruction set is an example of an instruction set where a set of registers can be organized as a stack where direct access to individual registers (relative to the top of stack) is also possible. It is typical to increment the position of the stack pointer or decrement the position of the stack pointer (relative to the current position) during completion of an overall task.

While conventional processor architectures would schedule and execute an FINCSTP (increment stack pointer) instruction in an execution unit (such as by executing a write instruction to write a new address into the stack pointer), the present disclosure achieves an advantage by completing the FINCSTP instruction without scheduling the use of an execution unit or using that execution unit in the completion of the instruction. That is, in one embodiment, the processor and method of the present disclosure pre-completes the FINCSTP instruction without use of the scheduling unit (30 in FIG. 2). In another embodiment, some execution operations may be scheduled, however, fewer execution units are required as compared to conventional processor architectures. As illustrated in FIG. 3A, the stack pointer 40 currently points to register 38-2 of the stack 38. Upon decoding a decrement stack pointer (FDECSTP) instruction, the present disclosure pre-completes that instruction by re-pointing the stack pointer as indicated by 40′. In a similar manner, the FINCSTP instruction can be pre-completed as indicated by 40″. In one embodiment, the rename unit (28 of FIG. 2) remaps the stack pointer without physically writing a new address into the stack pointer (move register and exchange registers instruction can also be pre-completed in this way). In another embodiment, the stack pointer can be incremented or decremented directly upon decoding the FINCSTP instruction in the decode unit (24 in FIG. 2). In any embodiment employed, the present disclosure pre-completes the FINCSTP (or the FDECSTP instruction as the case may be) without scheduling that instruction for processing in an execution unit or using that execution unit. By employing alternate or equivalent techniques or processes, instructions are pre-completed from the perspective of those execution units that are not engaged that would be employed in conventional processor architectures.

Referring now to FIG. 3B, a processor operational unit is illustrated showing an microarchitecture improvement to achieve instruction pre-completion. As an example, and not as a limitation, consider a floating-point operational unit (16 in FIG. 1) where a load instruction has been decoded (24 in FIG. 2) indicating that some value is to be loaded into a floating-point physical register address space of the floating-point register file control unit (32 in FIG. 2). Rather than use a floating-point execution unit to receive the load data and then write that data to a floating-point register file, the present disclosure contemplates that a dedicated write port 31 can be implemented in the microarchitecture of the floating-point operational unit to complete the load instruction directly and without use of the floating-point scheduler (30 in FIG. 2) or a floating-point execution unit (34 in FIG. 2) to complete the floating-point load instruction. Such an improvement in the microarchitecture of the floating-point unit can achieve substantial efficiency improvements and save operational cycles by pre-completing instructions that are commonly used in an instruction set (the load instruction in this example). Those skilled in the art will appreciate that this example is extendable to other operational units within the processor (10 of FIG. 1).

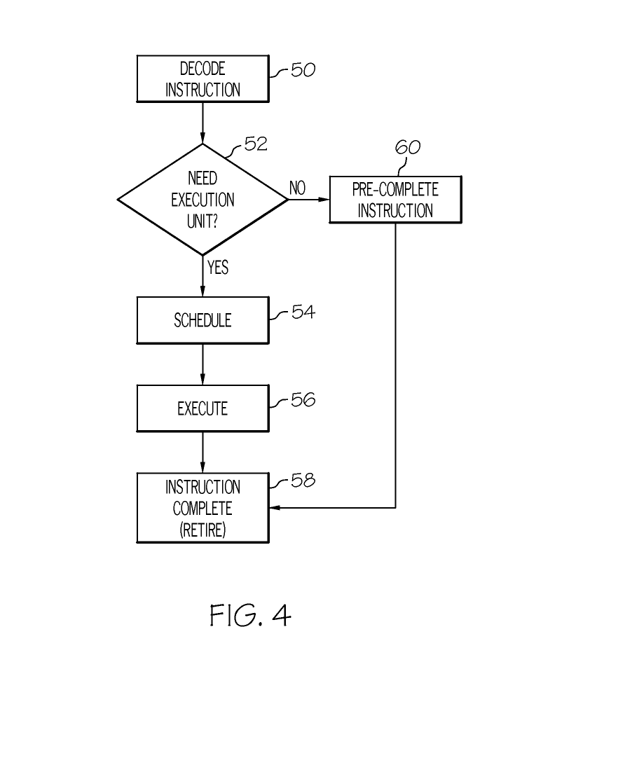

Referring now to FIG. 4, a flow diagram is shown illustrating the steps followed by various embodiments of the present disclosure for the processor 10, the floating-point unit 16, the integer unit 18 or any other unit 22 of the processor 10 that completes instructions without the use of execution units. In step 50, an instruction is decoded. Next, decision 52 determines if that instruction requires scheduling an execution unit for completion. If so, step 54 schedules the instruction for execution (30 in FIG. 3B). In step 56 the instruction is executed (34 in FIG. 3B) and the instruction is competed (on retired) as indicated in step 58. However, if the determination of decision 52 is that the instruction can be completed without an execution unit, the routine proceeds to step 60 where alternate or equivalent processes, techniques or the use of architectural improvements are employed to pre-complete the instruction, bypassing the scheduling and execution steps and the routine proceeds directly to providing an instruction complete indication at step 58. In another embodiment, if some execution units may be scheduled for use while others are not used that would otherwise be employed in conventional processor architectures. Thus, the present disclosure saves operational cycles and power consumption by eliminating use of some or all of the execution units for certain instructions where alternate or equivalent ways can be used to complete the instruction without scheduling an execution unit. Moreover, another instruction that requires the execution unit can be scheduled and completed by the execution unit which is available while the prior instruction is being pre-completed.

Various processor-based devices may advantageously use the processor (or computational unit) of the present disclosure, including laptop computers, digital books, printers, scanners, standard or high-definition televisions or monitors and standard or high-definition set-top boxes for satellite or cable programming reception. In each example, any other circuitry necessary for the implementation of the processor-based device would be added by the respective manufacturer. The above listing of processor-based devices is merely exemplary and not intended to be a limitation on the number or types of processor-based devices that may advantageously use the processor (or computational unit) of the present disclosure.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A method, comprising:
determining that an instruction can be pre-completed within an operational unit of a processor; and
pre-completing the instruction without using at least one execution unit within the operational unit of the processor.

2. The method of claim 1, wherein pre-completing further comprises using an alternate or equivalent process to complete the instruction.

3. The method of claim 2, wherein pre-completing further comprises using a renaming operation to complete the instruction.

4. The method of claim 1, wherein determining further comprises determining that the instruction to be completed without the execution unit of the processor comprises one of the group of instructions: increment stack pointer; decrement stack pointer; move register or exchange registers.

5. The method of claim 4, wherein pre-completing further comprises using an alternate or equivalent process to complete the instruction.

6. The method of claim 5, wherein pre-completing further comprises using a renaming operation to complete the instruction.

7. The method of claim 1, wherein determining further comprises determining that the instruction to be completed without the execution unit of the processor comprises determining that the instruction is a load instruction.

8. A processor, comprising:
an operational unit for determining whether an instruction can be completed without scheduling use of an execution unit of the processor; and
a unit within the operational unit configured to employ one or more alternate processes to complete the instruction;
wherein, the instruction is completed without scheduling use of the execution unit of the processor.

9. The processor of claim 8, wherein the operational unit comprises a decoder.

10. The processor of claim 8, wherein the unit configured to employ one or more alternate processes to complete the instruction comprises a decoder.

11. The processor of claim 8, wherein the unit configured to employ one or more alternate or equivalent processes to complete the instruction comprises a rename unit.

12. The processor of claim 8, wherein the unit configured to employ alternate one or more processes to complete the instruction comprises a unit having an architectural improvement for direct completion of the instruction without use of the execution unit.

13. The processor of claim 8, further comprising:
a scheduling unit for scheduling the instruction for completion responsive to a determination that the instruction requires scheduling the execution unit for completion.

14. The processor of claim 8, which includes other circuitry to implement one of the group of processor-based devices consisting of: a computer; a digital book; a printer; a scanner; a television or a set-top box.

15. A method, comprising:
decoding an instruction identifying one or more execution units of a processor to complete the instruction;
determining that the instruction can be completed without use of all of the one or more execution units; and
completing the instruction without use of at least one of the one or more execution units.

16. The method of claim 15, wherein completing the instruction comprises employing alternate or equivalent processes or techniques to complete the instruction.

17. The method of claim 16, wherein completing the instruction further comprises using a renaming operation to complete the instruction.
